(19) United States
(12) Patent Application Publication
(10) Pub. No.: US 2026/0044322 A1
(43) Pub. Date: Feb. 12, 2026

(54) DETECTING UNINITIALIZED VARIABLES DURING PROGRAM PRE-COMPILATION USING CONTROL FLOW GRAPHS

(71) Applicant: NVIDIA Corporation, Santa Clara, CA (US)

(72) Inventors: Pankaj MISTRY, Sunnyvale, CA (US); Vir NARULA, Sunnyvale, CA (US)

(21) Appl. No.: 18/797,838

(22) Filed: Aug. 8, 2024

(51) Int. Cl. G06F 8/41

(52) U.S. Cl. CPC G06F 8/41

(57) ABSTRACT

In various examples, static single assignment-based control flow graph traversal analysis for uninitialized variable detection system and methods are disclosed. A pre-compiler stage of a compiler system, may reconstruct source code into an SSA form IR and detect and identify uninitialized variables based on applying a variable analysis pass that traverses a CFG corresponding to the SSA form IR. A variable analysis pass may traverse through the CFG to build a defined variable map and a Phi variable map. The maps may be used to map undefined variables to basic blocks of the CFG where the undefined variables occur. The variable analysis pass may pass uninitialized variable data to a compiler error handling process. The compiler error handling process may produce an error report that traces the basic block with undefined variables to lines of the source code to assist in efficiently debugging the source code.

### BACKGROUND

A shader is a type of executable program that runs on a graphics processing unit (GPU). Shaders are often used to manipulate graphical elements of images before they are rendered to achieve visual effects in applications like video games and computer graphics, but may also be executed to perform other general-purpose computation tasks using a GPU. A general-purpose shader may sometimes be referred to as a compute shader, or as a kernel. While code for shaders was historically written in assembly language, high-level programming languages were later developed such as GLSL (OpenGL Shading Language), HLSL (High-Level Shading Language), and the NVIDIA Cg shading language, which are more easily understood by human programmers and can be readily applied to run on a range of different GPU hardware. During compilation, a shader compiler translates the high-level shader code into a format (e.g., low-level representations such as a bytecode or assembly-like code) that can be efficiently executed by the GPU. This compiled shader code can then be loaded and executed by the GPU during runtime to produce the desired graphical effects and/or other general-purpose computation. Just-In-Time (JIT) compiling is a technique used in programming where the compilation of code for a program is deferred until the program itself is run. That is, instead of pre-compiling an entire program before execution (sometimes referred to as offline compiling), the compilation of at least part of the code into machine code specific to the host system occurs at runtime, just before the code is executed. JIT compilation of shader code allows for optimizations that can take into account specific characteristics of the target platform, potentially improving the overall performance of the program during execution. Low-Level Virtual Machine (LLVM) is one example of a multi-programming language compiler architecture that may be used to perform JIT compiling of high-level shader code.

### SUMMARY

Embodiments of the present disclosure relate to static single assignment-based control flow graph traversal analysis for uninitialized variable detection. Systems and methods are disclosed that address the problem of detecting uninitialized variables of a program by using a static single assignment (SSA) intermediate representation (IR) control flow graph (CFG).

In contrast to conventional systems, with one or more of the embodiments described herein, a pre-compiler stage of a compiler system may reconstruct source code into an SSA form IR (an SSA-IR), and detect and identify uninitialized variables based on applying a variable analysis pass that traverses the corresponding CFG. In some embodiments, to identify uninitialized variables, the variable analysis pass may search the CFG to identify one or more program points that include a variable declaration instruction. The variable analysis pass may traverse through the CFG—through each instruction in each basic block—to build a defined variable map that may be subsequently used to map declared variables to basic blocks that involve SSA-based variable versions of those declared variables. The variable analysis pass may also evaluate each instruction in each basic block to identify program points that include a variable definition instruction. When the variable analysis pass determines that a program point comprises a variable definition instruction, the defined variable map may be updated to associate the SSA variable version defined by the variable definition instruction to its associated declared variable, and label the declared variable with a basic block identifier (ID) for the basic block(s) that includes a variable definition instruction. Moreover, once a variable version is defined, the variable analysis pass may proceed to propagate that variable version through the CFG to determine the reach of the variable version and the basic block ID of individual basic blocks that it reaches. Once the defined variable map is completed, the variable analysis pass may evaluate the map using one or more definition-use (DU) chains to find instances where uninitialized variables are used within basic blocks of the CFG.

In some embodiments, the variable analysis pass may also generate a Phi variable map as it traverses the CFG. As the variable analysis pass iteratively traverses through the CFG, it may also search for instructions that include a Phi function that defines a Phi variable. If an instruction does include a Phi function, then the variable analysis pass may create an entry in the Phi variable map that associates the Phi variable created by the Phi function with the basic block ID of the basic block that includes the Phi function. Using the defined variable map, the variable analysis pass may correlate basic block IDs identified from the Phi variable map to determine if variable versions for each of the inputs to the Phi function reach that basic block to initialize the variable inputs to the Phi function. When at least one of the variable version inputs to the Phi function was not initialized previously by a variable definition instruction that reaches that Phi function, then the Phi variable produced by that Phi function may be classified as an uninitialized Phi variable.

The variable analysis pass may pass uninitialized variable data to a compiler error handling process. The compiler error handling process may produce an error report or other output that uses the basic block IDs to trace the basic block that includes undefined variables to one or more lines of the source code input to assist in efficiently debugging the source code.

### BRIEF DESCRIPTION OF THE DRAWINGS

The present systems and methods for static single assignment-based control flow graph traversal analysis for uninitialized variable detection are described in detail below with reference to the attached drawing figures, wherein:

FIG. 1 is a data flow diagram for an example compiler system, in accordance with some embodiments of the present disclosure;

FIGS. 2 and 3 are diagrams illustrating an example variable analysis for identifying uninitialized variables and/or Phi variables for a compiler system, in accordance with some embodiments of the present disclosure;

FIG. 4 is a flow chart illustrating a method for variable analysis for identifying uninitialized variables for a compiler system, in accordance with some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

Systems and methods are disclosed related to static single assignment-based control flow graph traversal analysis for uninitialized variable detection.

The present disclosure relates to computer program compilers. More specifically, the systems and methods discussed herein provide for technologies that may be used to improve code quality and prevent errors in compiled code execution by detecting when a portion of source code includes instructions that use variables that have not been previously initialized and therefore may hold an undefined value.

The presence of uninitialized variables in program code represents a potentially serious programming error because the existence of uninitialized variables may result in unpredictable, undesirable, and/or undefined behavior during code execution. In a complex shader code comprising multiple condition-based execution branches, a declared variable may be assigned a definite value before use in some branches of the code, but remain uninitialized before use in other branches. When an uninitialized variable reaches a program point where it is used as an input to an operation, the resulting output of that operation may be unpredictable, and cause unknown conditions that can lead to program instability, buffer overflows, a program crash, and/or other potentially undetectable problems.

Data flow analysis represents an example of a technique that may be used to evaluate program code to identify uninitialized variables. For example, in some techniques, an abstract syntax tree (AST) may be generated that comprises a tree representation of the abstract structure of the source code for a program. Data flow analysis identifies how data flows through a program by tracking the values of variables computed and used by the program. The AST may be applied to a data flow analysis algorithm configured to perform a liveness analysis that calculates each program point in the source code where a declared variable is live—meaning that the variable holds an assigned value that is to be read and used at a subsequent program point. However, running a data flow analysis on an AST is very expensive with respect to computational resources in terms of compilation time (e.g., exhibiting a polynomial and/or exponential time complexity). This can be problematic; for example, in JIT compilation scenarios where the number of passes through the AST increases exponentially as a function of the number of lines of instruction in the shader code that is being compiled. The GNU Compiler Collection (GCC) is an example of a compiler system that performs data flow analysis of a source code's AST to identify uninitialized variables.

Another compiler that uses data flow analysis is the Clang frontend compiler of the LLVM compiler architecture. In contrast to GCC, Clang generates a control flow graph (CFG) from the source code's AST, which comprises a representation of the source code using graph notation to describe all of the paths through the various branches of the code that may be traversed during program execution. In a CFG, each node represents a basic block of code (a straight-line code sequence) with no branches in or out of the block except at the block's respective entry exit. The resulting CFG is applied to a data flow analysis algorithm to perform a liveness analysis to detect uninitialized variables. Although the CFG provides a more concise representation of the source code structure than the AST, running a data flow analysis on a CFG is still very expensive with respect to computational resources in terms of compilation time—with the number of passes through the CFG to complete the analysis increasing exponentially as a function of the number of lines of instruction. Moreover, Clang implements this uninitialized variable detection scheme as an offline tool. For both of these reasons, data flow analysis on a source code's CFG is not suited for JIT compilation scenarios of large shaders.

In contrast to these prior techniques for identifying uninitialized variables, embodiments of this disclosure address the problem of detecting uninitialized variables using a static single assignment (SSA) intermediate representation (IR) CFG of a program. More particularly, during a pre-compiler stage of the compilation process, the input program code (e.g., source code) may be reconstructed into an SSA form intermediate representation (referred to herein as the SSA-IR) wherein variables are split into variable versions. In the SSA-IR derived from the source code, each instruction instance where a given variable of the input code is defined and/or redefined, that definition instruction instance results in a distinct version of the variable. The new variable version may be noted in the SSA-IR by appending a unique subscript to the original variable name. Each definition instruction assigning a value to a variable thus constitutes a unique and independent instance of that variable. From the SSA-IR, the compilation process may then generate a corresponding CFG, as well as one or more definition-use chains (DU chains) and a dominator tree of the basic blocks that constitute the CFG.

For example, in some embodiments, an LLVM-generated SSA-IR may be produced from an initial source code for a program (e.g., shader). Using the SSA-IR, the LLVM compiler architecture may further produce the CFG, DU chains, and a dominator tree corresponding to the SSA-IR. A DU chain may be produced for each declared variable (e.g., a definition in a DU chain may refer to a program point where a variable is declared). The DU chain may comprise a data structure that describes where each version of a declared variable is defined and used by a program point on the CFG, and may also identify each of the program points of the SSA-IR that can reach that use without the occurrence of any other intervening definitions.

In some instances, the SSA-IR derived from the source code may also include one or more Phi variables that are generated at the start of a basic block. A Phi variable may be generated at basic block that includes a program point with an instruction that uses a variable whose value may vary depending on which path through the SSA-IR was traversed to reach that basic block. For example, where it is possible that multiple versions of a variable reach a basic block, that usage of the variable in the SSA-IR is represented by a Phi variable that is a function of those multiple versions of the variable, and at runtime will take the value of the variable version that corresponds to the execution path that lead to that basic block. For such Phi variables, a definition point in the context of their associated DU chain may be the program point where the Phi variable is created.

With respect to the dominator tree for the SSA-IR, the dominator tree is a data structure comprising nodes where each node represents a basic block of the CFG that has child nodes that it immediately dominates. Each basic block represented in the dominator tree is the immediate dominator of its child basic blocks so that dependencies between basic blocks of the CFG are easily identified.

As explained in greater detail below, as opposed to data flow analysis-based techniques, the SSA-based CFG analysis of an SSA-IR as described herein can detect and identify uninitialized variables in program code based on a single pass traversal of the corresponding CFG, representing a linear process in terms of compilation time that can be suitable for JIT compilation scenarios. In other words, whereas data flow analysis techniques represent an exponential increase in complexity and compilation time as a function of the size of the source code, the compilation time increase incurred using the SSA-based CFG analysis of the SSA-IR merely results in a linear increase as a function of the size of the source code because it can be completed using a single pass through the CFG. As a result, the compilation process for larger source codes may be completed within a time scale that supports JIT compilation scenarios.

Given the CFG, DU chains, and dominator tree corresponding to the SSA-IR, the variable analysis pass of the compilation process may proceed to the process of detecting and identifying uninitialized variable usage within the SSA-IR. The identified uninitialized variables may be mapped back to flag corresponding lines of the source code—which may be used by a programmer to debug the code.

In some embodiments, to identify uninitialized variables, the variable analysis pass may search the CFG to identify program points that include a variable declaration instruction. The variable declaration assigns a name to the variable, and may further indicate the data type that the variable may take as a value, such as, but not limited to: a floating point value, a double precision value, an integer value, a string value, or a Boolean value, for example. The variable declaration instruction is an indication to the compiler that the program intends to use that variable, and therefore identifying a set of declared variables produces a range of variables within which uninitialized variables may exist. As such, the variable analysis pass may traverse through the CFG—through each instruction in each basic block—to build a defined variable map that may be subsequently used to map declared variables to basic blocks that involve SSA-based variable versions of those declared variables. In some embodiments, the defined variable map may label a declared variable with a basic block identifier (ID) that uniquely identifies the basic block from the CFG that includes the variable declaration instruction that declared that variable.

As the variable analysis pass traverses the CFG to build the defined variable map, it may evaluate each instruction in each basic block to identify program points that include a variable definition instruction. A variable definition instruction may include an instruction that initializes a variable version of a declared variable (e.g., assigns an initial value to the variable version) or may include a function that generates a defined output that is stored to the variable version. As used herein, the terms “assign,” “define,” and “initialize” each may refer to the action of providing a known, defined value to a previously declared variable.

When the variable analysis pass determines that a program point comprises a variable definition instruction, the defined variable map may be updated to associate the SSA variable version defined by the variable definition instruction to its associated declared variable, and label the declared variable with the basic block ID for the basic block(s) that includes a variable definition instruction. For each subsequent instance where the variable analysis pass finds a variable definition instruction that produces another SSA variable version of that declared variable, the defined variable map may be updated to associate the additional variable version to its associated declared variable, and label the declared variable with the basic block ID for the basic block that includes that variable definition instruction.

Moreover, once a variable version is defined, the variable analysis pass may proceed to propagate that variable version through the CFG, which is a process that determines the reach of the now defined variable version and the basic block ID of individual basic blocks that it reaches. Propagation may be performed using a property of the CFG that defines each basic block that constitutes a successor basic block of the basic block that includes the variable definition instruction. In some embodiments, the definition of a variable version may be propagated to a basic block based on determining if a variable version of a declared variable is initialized as it exits a non-dominated predecessor basic block. Variable propagation may be performed using information from the dominator tree to determine where the variable version should be propagated and thus determine the basic blocks where that variable version is used—also known as the variable's reach. In some embodiments, the variable analysis pass includes a variable propagation function that propagates a variable's initialization to a basic block by checking if the variable is initialized when it exits non-dominated predecessors of that basic block. The propagation function may disregard predecessor basic blocks that are dominated by the basic block, because the basic block will be executed prior to the dominated predecessor block, which implies the variables initialized in a dominated predecessor do not reach the basic block upon first entry.

The defined variable map may be updated based on the propagation to reflect the basic blocks that are reached by the defined variable version. For example, the defined variable map may further label the declared variable associated with the propagated variable version with the basic block ID of each of the basic blocks that the variable version reaches. In this way, the defined variable map may be used to track each of the declared variables used by a basic block that have been defined using a variable definition instruction prior to the entry of the basic block. The defined variable map thus establishes the set of declared variables that are to be tracked for being potentially uninitialized, and may indicate the set of program points that include instructions to initialize the SSA versions of those variables, as well as the set of basic blocks for which the SSA variable versions are initiated upon entering.

In some embodiments, the variable analysis pass may iteratively traverse through the CFG of the SSA-IR to analyze the instructions at each program point in each basic block to determine if the instructions are a variable use instruction, such as a variable declaration instruction or a variable definition instruction (or in some embodiments, as further discussed below, a Phi variable/Phi function instruction). The variable analysis pass may first determine whether an instruction includes a variable declaration instruction, and when it detects a variable declaration instruction, the defined variable map may be updated to add an entry for the declared variable as discussed above. If the instruction does not include a variable declaration instruction, the variable analysis pass may next determine whether the instruction instead includes a variable definition instruction for a variable version. When it detects a variable definition instruction, the entry for the declared variable may be updated as discussed herein to identify the basic blocks where the variable version was defined. The variable version may be propagated using the computed dominator tree for the SSA-IR and the reach of the defined variable version documented by updating the defined variable map with the basic block IDs of the basic blocks reached by that variable version. These iterations may proceed until each instruction of each basic block of the CFG is traversed by the variable analysis pass, resulting in a completed defined variable map that can be evaluated to look for occurrences of uninitialized variable usage.

Once the defined variable map is completed, the variable analysis pass may evaluate the map using DU chains to find instances where uninitialized variables are used within basic blocks of the CFG. For each respective declared variable identified in the defined variable map, the variable analysis pass may follow a DU chain for the associated SSA variable versions. Based on the DU chain for a variable version, the variable analysis pass may determine the basic block ID of a basic block where the variable version was defined and each basic block ID of the one or more basic blocks that use that variable version. The variable analysis pass may cross-reference those basic block IDs using the defined variable map. For example, to confirm whether a variable version used by a basic block is initialized, the variable analysis pass can reference the basic block ID of the basic block where use occurs as indicated by the DU chain to the defined variable map. The variable analysis pass references the collected information associated with that basic block (e.g., a declared variable entry) to determine if the defined variable map labels the basic block as a block where that variable version was previously defined by a variable definition instruction. That is, the variable analysis pass determines if the propagation of that variable version previously performed by the variable analysis pass reaches the entry to that basic block. If so, then the usage of the associated declared variable is considered properly initialized with respect to that basic block. If the defined variable map does not indicate that the basic block was labeled by the propagation as a block reached by the variable version, then the variable analysis pass may flag that basic block (e.g., by reference to its basic block ID) as containing a usage of an uninitialized variable version. For example, the variable analysis pass may pass uninitialized variable data to a compiler error handling process indicating the name of the declared variable associated with the uninitialized variable version along with the basic block ID of the basic block where the uninitialized variable usage occurred. In some embodiments, the compiler error handling process may produce an error report or other output that uses the basic block ID to trace the basic block (e.g., using the CFG) to one or more lines of the high-level source code input and flags those one or more lines as including an uninitialized use of the declared variable.

As previously mentioned, as the SSA-IR is generated, Phi variables may be generated and placed at the start of a basic block when that basic block includes a program point with an instruction that uses a variable whose value may vary depending on which path through the SSA-IR was traversed to reach that basic block. For example, for a given SSA-IR there may be instances where a first defined variable version of a declared variable reaches a basic block via a first possible execution path through the SSA-IR, and a second defined variable version of that declared variable reaches the basic block via a second possible execution path through the SSA-IR. Such instances may occur where the CFG includes condition-based branches that control code execution to follow the first execution path during a first set of conditions, and to follow the second execution path during a second set of conditions. If the first path and second path each include a variable definition instruction that assigns a value to a declared variable, then each path will generate a distinct variable version of that variable that reaches the basic block. A Phi variable may be generated within the basic block by treating the Phi variable as another variable version of the declared variable, and may assign that Phi variable a value defined by an SSA Phi function (which may be referred to herein as a Phi function) that inputs the distinct variable versions that reach that basic block via the distinct execution paths. However, if at least one input to the Phi function represents an uninitialized variable, the Phi variable defined by that Phi function may also constitute an uninitialized variable depending on which execution path was executed.

For this reason, to track basic blocks that create Phi variables, the variable analysis pass may also generate a Phi variable map, for example, as it traverses the CFG to generate the defined variable map. As the variable analysis pass iteratively traverses through the CFG of the SSA-IR to analyze the instructions at each program point in each basic block, it may determine if the instructions of a basic block are a variable declaration instruction or a variable definition instruction (as discussed above), and it may also check to see if the instructions include a Phi function that defines a Phi variable. If an instruction does include a Phi function, then the variable analysis pass may create an entry in the Phi variable map that associates the Phi variable created by the Phi function with the basic block ID of the basic block that includes the Phi function. The variable analysis pass may further associate the Phi variable with the multiple SSA variable versions of the declared variable that are inputs to the Phi function. Once the variable analysis pass completes its traversal of the CFG, in addition to producing the completed defined variable map as discussed above, in some embodiments, it may have also produced a complete Phi variable map that identifies each of the basic blocks where Phi variables were used, as well as the variable versions that the Phi variable depends on.

In some embodiments, the variable analysis pass may perform a recursive flattening of the multidimensional Phi variable map into a flattened (e.g., one-dimensional) list that associates Phi function inputs to basic block IDs so that the flattened list thus represents a list of declared variables that are associated with Phi variables. Using the defined variable map, the variable analysis pass correlates the basic block IDs from the flattened Phi variable map to determine if variable versions from previous variable definition instructions for each of the inputs to the Phi function reach that basic block to initialize the variable inputs to the Phi function. When all of the variable version inputs to the Phi function are found to be initialized previously by a variable definition instruction that reaches that Phi function, then the Phi variable produced by the Phi function may be classified as a properly initialized Phi variable. In contrast, when at least one of the variable version inputs to the Phi function was not initialized previously by a variable definition instruction that reaches that Phi function, then the Phi variable produced by that Phi function may be classified as an uninitialized Phi variable and/or otherwise may be added to a list of uninitialized Phi variables.

The variable analysis pass may evaluate the list of uninitialized Phi variables using DU chains to find instances in basic blocks where the uninitialized Phi variables are used. For each respective uninitialized Phi variable, the variable analysis pass may follow a DU chain and determine the basic block ID of one or more basic blocks where the uninitialized Phi variable was generated and each basic block ID of the one or more basic blocks that use that uninitialized Phi variable. In some embodiments, the variable analysis pass may pass to the compiler error handling process uninitialized variable data indicating the name of the declared variable associated with the uninitialized Phi variable along with the basic block ID of the basic block(s) where use of the uninitialized Phi variable occurred. In some embodiments, the compiler error handling process may produce an error report or other output that uses the basic block ID to trace the basic block (e.g., using the CFG) to one or more lines of the high-level source code input and flags those one or more lines as including an uninitialized use of the declared variable.

In various embodiments, a source code compilation process implementing an SSA-IR-based variable analysis pass as described herein may be performed in conjunction with a compiler executed on any computing platform or combination of platforms such as, but not limited to, a desktop computer, a smart device, and/or a cloud-based computing platform. Moreover, the SSA-IR based variable analysis pass may be executed in conjunction with an offline compiling process or JIT compiling processes. The compilation processes are not limited to compiling of shader code for execution on GPUs. In various embodiments, the SSA-IR-based variable analysis pass may be used in conjunction with compiling any program code using an SSA form-based compiler. As such, the SSA-IR-based variable analysis pass may be used to detect initiated variables in program code being compiled for execution on a computing platform comprising one or more central processing units (CPUs), one or more GPUs, or other processing devices or combinations thereof.

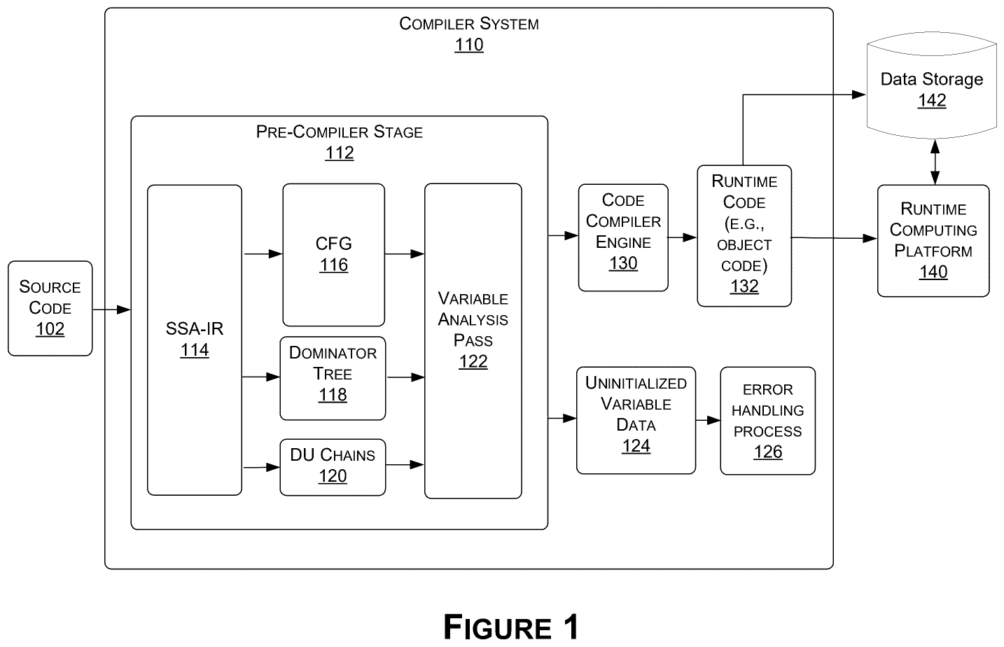

With reference to FIG. 1, FIG. 1 is an example data flow diagram for a compiler system 110, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software, or any combination thereof. For instance, various functions may be carried out by a processor executing instructions stored in memory.

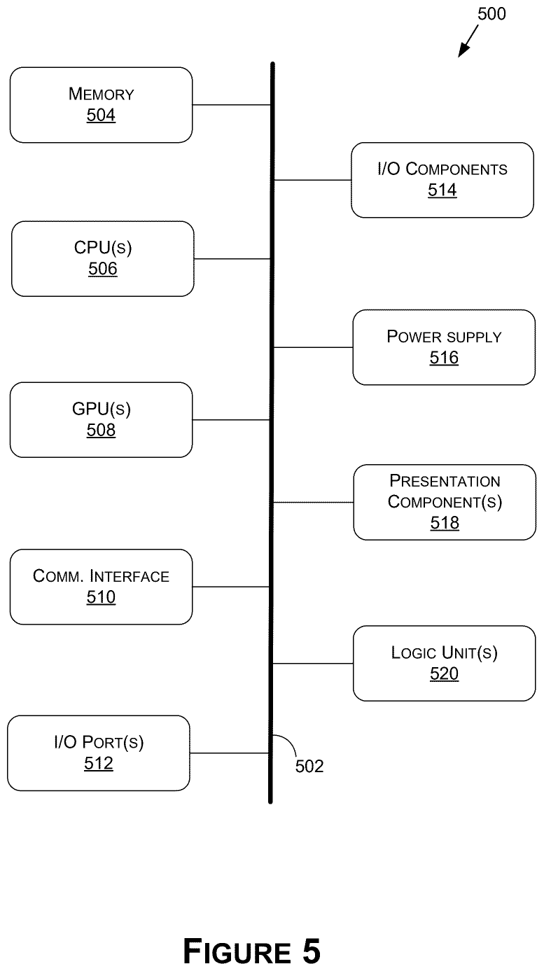

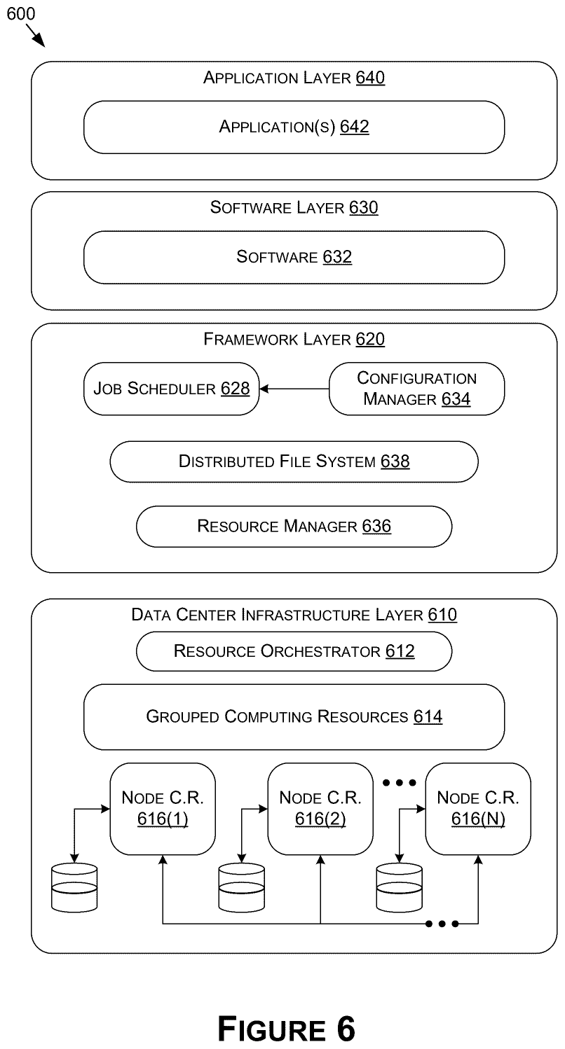

As shown in FIG. 1, the compiler system 110 comprises a code compiler engine 130 that generates runtime code 132 (e.g., object code) for execution on a runtime computing platform 140 based on source code 102 input to the compiler system 110. In some embodiments, the source code 102 may comprise high-level shader code (e.g., shader code produced using GLSL, HLSL, or Cg) to implement tasks to be performed on a runtime computing platform 140 comprising GPU hardware. In some embodiments, the source code 102 may comprise high-level general-purpose programming code to implement tasks to be performed on a runtime computing platform 140 comprising CPU hardware, GPU hardware, and/or other processing architectures. Based on the source code 102, the code compiler engine 130 may produce the runtime code 132 to implement those tasks on the runtime computing platform 140. In some embodiments, one or more functions of the compiler system 110 and/or the runtime computing platform 140 may be implemented using one or more of the computing device(s) 500 described with respect to FIG. 5 and/or a data center 600 as described with respect to FIG. 6.

In some embodiments, the runtime code 132 may be stored to a data storage 142 from which it can be read by the runtime computing platform 140 to execute the runtime code 132. In some embodiments, the compiler system 110 may implement a JIT compiling system wherein the runtime code 132 is received from the compiler system 110 and directly executed in real-time. In some embodiments, the compiler system 110 may comprise a Low-Level Virtual Machine (LLVM) compiler architecture. In some embodiments, one or more functions of the compiler system 110 and runtime computing platform 140 may be integrated together in a combined computing platform.

In the embodiment shown in FIG. 1, the compiler system 110 comprises a pre-compiler stage 112 that inputs and processes the source code 102 before the code compiler engine 130 produces the runtime code 132. The pre-compiler stage 112 includes a variable analysis pass 122 for detecting uninitialized variables in the source code 102 using a static single assignment (SSA) intermediate representation (IR) CFG of the source code 102. In some embodiments, the pre-compiler stage 112 reconstructs the source code 102 into an SSA-IR 114. In the SSA-IR 114 derived from the source code, each instruction instance where a given variable is defined and/or redefined, that definition instruction instance results in a distinct SSA version of the variable (referred to herein as a variable version). The new variable version may be noted in the SSA-IR 114 by appending a unique subscript to the original variable name. Each definition instruction assigning a value to a variable thus constitutes a unique and independent instance of that variable. From the SSA-IR 114, the pre-compiler stage may generate a corresponding CFG 116, one or more DU chains 120, and a dominator tree 118 representation of the basic blocks that constitute the CFG 116.

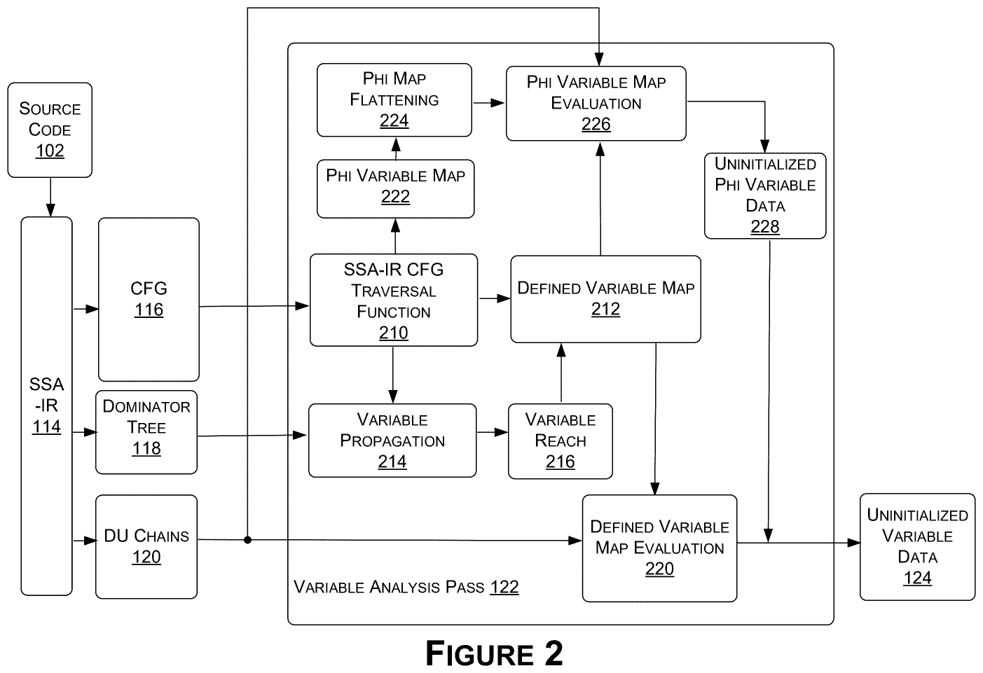

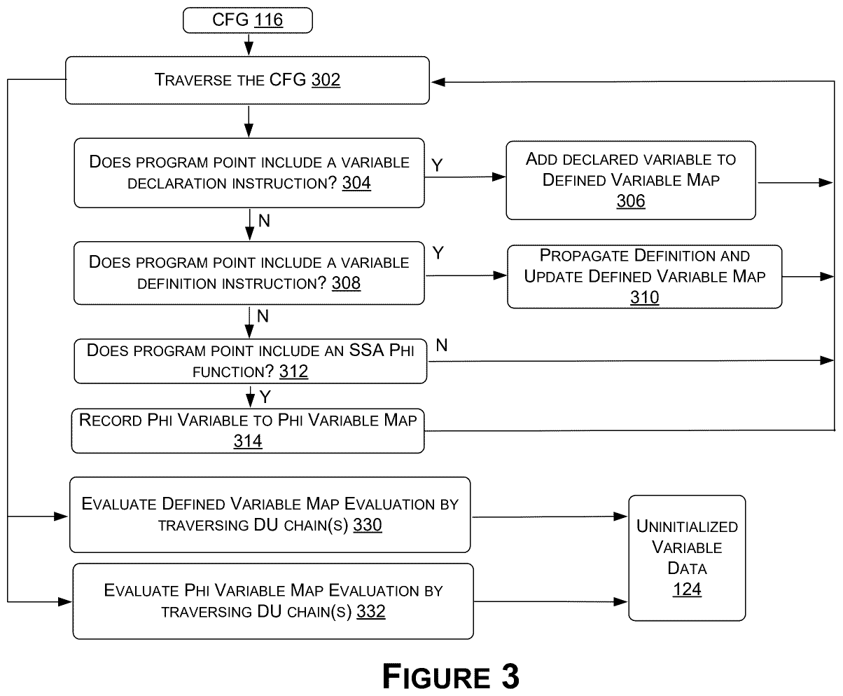

As explained in greater detail below with respect to FIGS. 2 and 3, the variable analysis pass 122 may traverse the CFG 116 to search for and identify occurrences of uninitialized variables (e.g., standard variables and/or Phi variables) that would cause the code compiler engine 130 to fail to successfully generate the runtime code 132 and/or result in unpredictable or undefined behavior when runtime computing platform attempts to execute the runtime code 132. Accordingly, in some embodiments, the code compiler engine 130 may proceed to generate the runtime code 132 based on a determination by the variable analysis pass 122 that the source code 102 does not include uninitialized variables. Otherwise, when the variable analysis pass 122 determines that the source code 102 does include uninitialized variables, the variable analysis pass 122 may output uninitialized variable data 124 to an error handling process 126 of the compiler system 110. For example, the uninitialized variable data 124 may indicate to the error handling process 126 the name of one or more declared variables that have associated with them one or more uninitialized variable versions. The uninitialized variable data 124 may further indicate the basic block IDs of basic blocks of the source code 102 where the uninitialized variable usage occurred. In some embodiments, the error handling process 126 may produce an error report or other output that uses the basic block ID(s) to trace the basic block (e.g., using the CFG 116) to one or more lines of the source code 102 in order to flag those lines as including an uninitialized use of the declared variable. The error report may be used (e.g., by a code developer) to efficiently debug the source code 102 by ridding the source code 102 of instructions using undefined variables. In embodiments, the variable analysis pass 122 can detect and identify uninitialized variables in program code based on a single pass traversal of the corresponding CFG 116, representing a linear process in terms of compilation time that can be performed in sufficiently short enough times to support JIT compilation scenarios or other compilation scenarios.

FIG. 2 is a block diagram illustrating an example variable analysis pass 122 to search for uninitialized variables, in accordance with some embodiments of the present disclosure. As shown in FIG. 2, the variable analysis pass 122 may include an SSA-IR CFG traversal function 210, a defined variable map 212, a variable propagation function 214, and a defined variable map evaluation function 220. One or more of these elements of the variable analysis pass 122 may implement a process such as illustrated in FIG. 3 to generate uninitialized variable data 124 that identifies uninitialized variables from the source code 102.

Starting at 302 in FIG. 3, the SSA-IR CFG traversal function 210 may input the CFG 116 (for the SSA-IR 114) and traverse through each instruction (e.g., program point) in each basic block of the CFG 116 searching for variable declaration instructions and variable definition instructions in order to build the defined variable map 212. At 304, the SSA-IR CFG traversal function 210 may evaluate a CFG 116 program point to determine if the program point includes a variable declaration instruction. A variable declaration instruction may create a variable by assigning a name and/or data type to the variable. When the SSA-IR CFG traversal function 210 at 304 identifies that the program point includes a variable declaration instruction, a record for the declared variable may be added to the defined variable map 212, as shown at 306. For declared variables recorded to the defined variable map 212, a record for that variable may indicate the basic block ID of the basic block from the CFG 116 where the variable declaration instruction is located.

When the program point does not include a variable declaration instruction, then at 308 the SSA-IR CFG traversal function 210 may evaluate the CFG 116 program point to determine if the program point includes a variable definition instruction. A variable definition instruction may include, for example, an instruction that initializes a declared variable by assigning a value to the variable, or may include a function that computes an output that is stored to the variable. When the SSA-IR CFG traversal function 210 determines at 308 that the program point does include a variable definition instruction, the defined variable map 212 may be updated at 310 to add an indication of the variable definition instruction (and the basic block ID of the variable definition instruction) to the record for the previously declared variable within the defined variable map 212. In some embodiments, the record for the declared variable in the defined variable map 212 may be labeled with the basic block ID of the program point that includes the variable definition instruction.

In some embodiments, when a variable definition instruction is identified by the SSA-IR CFG traversal function 210, the variable propagation 214 is then applied to determine the variable reach 216 of the variable definition within the CFG 116. The defined variable map 212 may be further updated at 260 to correlate that reach with the record for the variable declaration. That is, the variable propagation 214 propagates the SSA variable version generated by the variable definition instruction through the CFG 116 and records the basic block IDs of the reached basic blocks to the record for the declared variable. In some embodiments, the variable propagation 214 may be performed using the CFG 116 based on data from the CFG 116 that defines each basic block that constitutes a successor basic block of the basic block that includes the identified variable definition instruction. In some embodiments, the variable propagation 214 may propagate a definition of a variable version to a basic block based on determining if a variable version of a declared variable is initialized as it exits a non-dominated predecessor basic block.

In some embodiments, the variable propagation 214 may be performed using information from the dominator tree 118 to determine where within the CFG 116 the variable version should be propagated. Using the dominator tree 118, the variable propagation 214 may determine the basic blocks of the CFG 116 where that variable version is used—which indicates the variable reach 216 associated with that variable definition instruction. The variable propagation 214 may propagate a variable's initialization to a basic block by checking if the variable is initialized when it exits non-dominated predecessors of that basic block. The variable propagation 214 may disregard predecessor basic blocks that are dominated by the basic block, because the basic block will be executed prior to the dominated predecessor block, which implies the variables initialized in a dominated predecessor do not reach the basic block upon first entry.

At 310, variable propagation 214 may also update the defined variable map 212 based on the variable reach 216 to reflect the basic blocks that are reached by the defined variable version. The defined variable map 212 may label the declared variable associated with the propagated variable version with the basic block ID of each of the basic blocks that the variable version reaches.

Once a program point has been determined to include either a variable declaration instruction or a variable definition instruction, and the defined variable map 212 is updated accordingly, the SSA-IR CFG traversal function 210 may return to 302 and proceed to evaluate the next program point indicated by the CFG 116—continuing to iteratively traverse the CFG 116 while generating a defined variable map 212 that represents a comprehensive indication of variables declared and defined within the source code 102, indicates the basic blocks where those declaration and definition instructions are located, and indicates the corresponding reach (e.g., in terms of basic block IDs) of each of the SSA variable versions produced by the usage of those variables within the source code 102. A completed defined variable map 212 thus establishes a comprehensive set of declared variables that may be evaluated as being potentially uninitialized. The completed defined variable map 212 may indicate the set of program points that includes instructions to initialize the SSA versions of those declared variables, as well as the set of basic blocks for which the SSA variable versions are initiated upon entering. The search through the basic blocks and program points of the CFG 116 may be iteratively performed until each instruction of each basic block of the CFG 116 is traversed, resulting in a completed defined variable map 212 that can be evaluated for occurrences of uninitialized variable usage.

As also shown in FIG. 2, in some embodiments, the variable analysis pass 122 may include a defined variable map evaluation 220 that may be applied to the completed defined variable map 212 (e.g., after traversal of the CFG 116 is complete) to generate uninitialized variable data 124. The defined variable map evaluation 220 may evaluate the defined variable map 212 by using the DU chains 120 (e.g., determined from the SSA-IR 114) to find instances where uninitialized variables are used within basic blocks of the CFG 116.

As shown in FIG. 3, when the traversal of the CFG 116 is complete, the process may proceed from 302 to 330. At 330, the defined variable map evaluation 220 can be performed where for each record of a declared variable in the defined variable map 212, the defined variable map evaluation 220 may follow the corresponding DU chains 120 for the SSA variable versions of that declared variable. Based on cross-referencing the DU chains 120 with the defined variable map 212, the defined variable map evaluation 220 may determine the basic block IDs of each basic block where declared variables were defined, as well as the basic block IDs of the one or more basic blocks that use variable versions of those declared variables.

For example, to confirm whether a variable version used by a basic block is initialized, the defined variable map evaluation 220 can reference the basic block ID of the basic block where use occurs (as indicated by the DU chain 120) to the defined variable map 212. The defined variable map evaluation 220 may reference the collected information associated with that basic block with the records of defined variable map 212 to determine if the defined variable map 212 indicates that the basic block is a block where that variable version was previously defined by a variable definition instruction. For example, the defined variable map evaluation 220 may determine if a previously performed variable propagation 214 produced a variable reach 216 that reaches the entry to that basic block. If so, then the usage of the associated declared variable is considered properly initialized with respect to that basic block. If the defined variable map 212 does not indicate that the basic block was reached by variable propagation 214, then the defined variable map evaluation 220 may generate uninitialized variable data 124 that indicates that basic block (e.g., by reference to its basic block ID) as including an instruction that uses an uninitialized variable version. The variable analysis pass 122 may pass the uninitialized variable data 124 to the error handling process 126 for further processing, as discussed herein.

Referring again to FIG. 3, in some embodiments, when the SSA-IR CFG traversal function 210 determines that a program point does not include a variable declaration instruction or a variable definition instruction, then at 312 the SSA-IR CFG traversal function 210 may determine if the program point includes an SSA Phi function. As previously mentioned, for SSA-based compilers, the source code 102 may be reconstructed into an SSA form intermediate representation (e.g., SSA-IR 114) wherein variables are split into variable versions when they are assigned new values at different program points of the CFG 116. Additionally, the SSA-IR 114 derived from the source code 102 may also include one or more Phi variables that are generated by a Phi function at the start of a basic block. A Phi variable may be generated at a basic block when that basic block includes a program point with an instruction that uses a variable whose value may vary depending on which path through the SSA-IR was traversed to reach that basic block. Such instances may occur where the CFG 116 includes condition-based branches that control code execution to follow a first execution path during a first set of conditions, and to follow the first execution path during a second set of conditions. Each path may generate a distinct variable version of that variable that reaches the basic block. A Phi variable may be generated within the basic block by treating the Phi variable as another variable version of the declared variable, and assigned that Phi variable a value defined by a Phi function that inputs the distinct variable versions that reach that basic block via the distinct execution paths. Accordingly, as shown with reference to FIG. 2, in some embodiments, the variable analysis pass 122 may include a Phi variable map 222 generated by the SSA-IR CFG traversal function 210.

When the SSA-IR CFG traversal function 210 at 312 determines that a program point does not include am SSA Phi function, then traversal of the CFG 116 may return to 302 and proceed to evaluate the next program point indicated by the CFG 116. When the SSA-IR CFG traversal function 210 at 312 determines that a program point does include an SSA Phi function, then the SSA-IR CFG traversal function 210 at 314 may create an entry in the Phi variable map 222 that associates the Phi variable created by the Phi function with the basic block ID of the basic block that includes the Phi function. The Phi variable map 222 may associate the Phi variable with the multiple SSA variable versions of the declared variables that are inputs to the Phi function identified at the program point. Once the Phi variable map 222 is updated accordingly, the SSA-IR CFG traversal function 210 may return to 302 and proceed to evaluate the next program point indicated by the CFG 116. As such, generation of the Phi variable map 222 may be performed as part of the traversal of the CFG 116 where the defined variable map 212 is generated so that both maps may be obtained through a single traversal of the CFG 116.

When the traversal of the CFG 116 is complete, the process may proceed to 332 where the Phi variable map 222 may be processed by the variable analysis pass 122. More specifically, at 332 the variable analysis pass 122 may evaluate the Phi variable map 222 using the DU chain(s) 120 to identify occurrences of uninitialized phi variables from the CFG 116.

Referring again to FIG. 2, in some embodiments, when the variable analysis pass 122 completes the traversal of the CFG 116, in addition to producing the completed defined variable map 212, it may have also produced a complete Phi variable map 222 that identifies each of the basic blocks where Phi variables were used, and the variable versions that the Phi variable depends on. In some embodiments, the variable analysis pass 122 may process the completed Phi variable map 222 using Phi map flattening 224. That is, the Phi variable map 222 as generated by the SSA-IR CFG traversal function 210 may comprise a complex nested data structure based at least in part on the multiple paths through the CFG 116 that can lead to each Phi function. Phi map flattening 224 may perform a recursive flattening of the Phi variable map 222 into a flattened structure (e.g., a one-dimensional list and/or tabular format) that associates each of the Phi function inputs (e.g., variable versions arriving at the function from different paths) to basic block IDs. The resulting flattened structure thus represents a catalogue of declared variables that are associated with Phi variables.

Using the defined variable map 212, the variable analysis pass 122 may perform a Phi variable evaluation 226 to correlate the basic block IDs provided by the flattened Phi variable map (the output from Phi map flattening 224) to determine for each Phi function if variable versions from previous variable definition instructions for each of the inputs to the Phi function reach that basic block to initialize the variable inputs to the Phi function. When all of the variable version inputs to a Phi function are found to be initialized previously by a variable definition instruction that reaches that Phi function, then the Phi variable evaluation 226 may classify the Phi variable produced by the Phi function as a properly initialized Phi variable. In contrast, when the Phi variable evaluation 226 determines that at least one of the variable version inputs to a Phi function was not initialized previously by a variable definition instruction that reaches that Phi function, then the Phi variable evaluation 226 may classify the Phi variable produced by that Phi function as an uninitialized Phi variable. Phi variables classified as uninitialized Phi variables may be added to a list of uninitialized Phi variables.

In some embodiments, the Phi variable evaluation 226 may further evaluate the list of uninitialized Phi variables using DU chains 120 to find instances in basic blocks where the uninitialized Phi variables are used—which may be used to produce uninitialized Phi variable data 228. For each respective uninitialized Phi variable, the Phi variable evaluation 226 may follow a DU chain 120 and determine the basic block ID of one or more basic blocks where the uninitialized Phi variable was generated, as well as each basic block ID of the one or more basic blocks that use that uninitialized Phi variable. The basic block ID of basic blocks identified as generating and/or using an uninitialized Phi variable may be included in the uninitialized Phi variable data 228.

As shown in FIG. 2, in some embodiments, the variable analysis pass 122 may include the uninitialized Phi variable data 228 with the uninitialized variable data 124, which may be passed to the error handling process 126 and processed to debug the source code 102 as discussed herein.

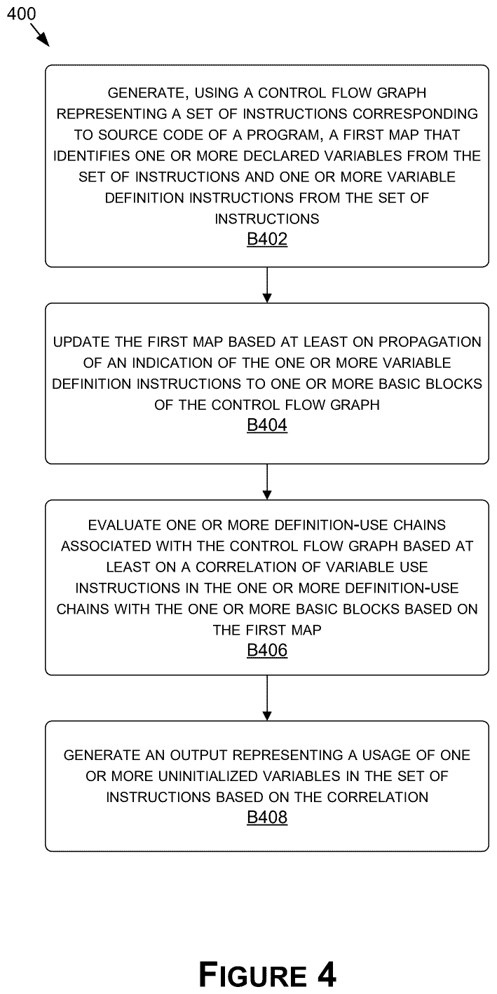

Now referring to FIG. 4, FIG. 4 is a flow diagram showing a method 400 for variable analysis for identifying uninitialized variables for a compiler system, in accordance with some embodiments of the present disclosure. It should be understood that the features and elements described herein with respect to the method 400 of FIG. 4 may be used in conjunction with, in combination with, or substituted for elements of any of the other embodiments discussed herein and vice versa. Further, it should be understood that the functions, structures, and other descriptions of elements for embodiments described in FIG. 4 may apply to like or similarly named or described elements across any of the figures and/or embodiments described herein and vice versa. Each block of method 400, described herein, comprises a computing process that may be performed using any combination of hardware, firmware, and/or software. For instance, various functions may be carried out by one or more processors comprising processing circuitry to execute instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 400 is described, by way of example, with respect to the system of FIG. 1. However, this method may additionally or alternatively be executed by any one system, or any combination of systems, including, but not limited to, those described herein.

As discussed herein in greater detail, the method may include generating an output representing a usage of one or more uninitialized variables in a set of instructions corresponding to a program based at least on one or more maps associated with a control flow graph of the set of instructions, and to correlate one or more variable use instructions from the set of instructions with one or more basic blocks of the control flow graph based on the one or more maps.

The method 400, at block B402, includes using a control flow graph representing a set of instructions corresponding to a program source code, generating, using a control flow graph representing a set of instructions corresponding to source code of a program, a first map that identifies one or more declared variables from the set of instructions and one or more variable definition instructions from the set of instructions. The set of insructions may comprise a static single assignment (SSA) intermediate representation (IR) of the program source code. For example, as discussed with repsect to FIG. 2, a variable analysis pass 122 for a compiler system 110 a SSA-IR CFG traversal function 210 may input the CFG 116 and traverse through each instruction in each basic block of the CFG 116 searching for variable declaration instructions and variable definition instructions, to build the defined variable map 212. The SSA-IR CFG traversal function 210 may evaluate a CFG 116 program point to determine if the program point includes a variable declaration instruction. When the SSA-IR CFG traversal function 210 identifies that the program point includes a variable declaration instruction, a record for the declared variable may be added to the defined variable map 212. A record for that variable may indicate the basic block ID of the basic block from the CFG 116 where the variable declaration instruction is located. When the SSA-IR CFG traversal function 210 determines that a program point includes a variable definition instruction, the defined variable map 212 may be updated at 310 to add an indication of the variable definition instruction (and the basic block ID of the variable definition instruction) to the record for the previously declared variable within the defined variable map 212.

The method 400, at block B404, includes updating the first map based at least on propagation of an indication of the one or more variable definition instructions to one or more basic blocks of the control flow graph. The method may include propagating the indication of the one or more variable definition instructions to the one or more basic blocks of the control flow graph based on a tree (e.g., a dominator tree) corresponding to a set of basic blocks included in the control flow graph. For example, in some embodiments, when a variable definition instruction is identified by the SSA-IR CFG traversal function 210, the variable propagation 214 is then applied to determine the variable reach 216 of the variable definition within the CFG 116. The defined variable map 212 may be further updated at 260 to correlate that reach with the record for the variable declaration. The variable propagation 214 may be performed using information from the dominator tree 118 to determine where within the CFG 116 the variable version should be propagated. The variable propagation 214 may also update the defined variable map 212 based on the variable reach 216 to reflect the basic blocks that are reached by the defined variable version.

The method 400, at block B406, includes evaluating one or more definition-use chains associated with the control flow graph based at least on a correlation of variable use instructions in the one or more definition-use chains with the one or more basic blocks based on the first map. The variable analysis pass 122 may include a defined variable map evaluation 220 that may be applied to the completed defined variable map 212 (e.g., after traversal of the CFG 116 is complete) to generate uninitialized variable data 124. The defined variable map evaluation 220 may evaluate the defined variable map 212 by using the DU chains 120 to find instances where uninitialized variables are used within basic blocks of the CFG 116. The defined variable map evaluation 220 may follow the corresponding DU chains 120 for the SSA variable versions of that declared variable. Based on correlating the DU chains 120 with the defined variable map 212, the defined variable map evaluation 220 may determine the basic block IDs of each basic block where declared variables were defined, and the basic block IDs of the one or more basic blocks that use variable versions of those declared variables.

In some embodiments, the one or more basic blocks of the control flow graph in the first map (e.g., the defined variable map 212) may be identified based on one or more basic block identifiers that uniquely identify individual basic blocks. The first map may indicate, based on a basic block identifier, when a declared variable used by the one or more basic blocks has been defined using at least one of the one or more variable definition instructions prior to an entry to the one or more basic blocks.

The method 400, at block B408, includes generating an output representing a usage of one or more uninitialized variables in the set of instructions based on the correlation. The method may generate uninitialized variable data such as, but not limited to, a report comprising at least an indication of one or more portions of the program source code that use the one or more uninitialized variables. For example, when the variable analysis pass 122 determines that the source code 102 does include uninitialized variables, the variable analysis pass 122 may output uninitialized variable data 124 to an error handling process 126 of the compiler system 110. The method may proceed to compile the set of insructions into a machine-executable code (e.g., runtime code 132) when the output representing the usage of one or more uninitialized variables indicates that the set of insructions does not include uninitialized variables. The method may correlate one or more variable use instructions with the one or more basic blocks based on the first map, and generate an output representing a usage of one or more uninitialized variables based on the correlation.

In some embodiments the method may further include generating a second map that identifies one or more Phi functions from the set of instructions, such as Phi variable map 222. The second map may associate the one or more Phi functions with a set of one or more basic blocks of the control flow graph that include the one or more Phi functions. As illustrated in FIG. 2, when the SSA-IR CFG traversal function 210 determines that a program point does include a Phi function, then the SSA-IR CFG traversal function 210 may create an entry in the Phi variable map 222 that associates the Phi variable created by the Phi function with the basic block ID of the basic block that includes the Phi function. The Phi variable map 222 may associate the Phi variable with the multiple SSA variable versions of the declared variables that are inputs to the Phi function identified at the program point.

In some embodiments, the method may determine when variable inputs to the one or more Phi functions are reached by the one or more variable definition instructions based on a second correlation of the second map with the first map and the one or more definition-use chains associated with the control flow graph. A recursive flattening of the second map into a flattened list (such as performed by Phi map flattening 224) may be performed that associates the variable inputs to the one or more Phi functions with one or more basic block identifiers (IDs). The output representing the usage of one or more uninitialized variables may be generated further based on the second correlation using the DU chains 120 between the flattened Phi variable map 222 and the defined variable map 212 to identify basic blocks of the source code where Phi variables are used that are less than fully initialized.

As opposed to data flow analysis-based techniques, the SSA-based CFG analysis of an SSA-IR as described with respect to method 400 and the other embodiments described herein can detect and identify uninitialized variables in program code based on a single pass traversal of the corresponding CFG, representing a linear process in terms of compilation time that can be suitable for JIT compilation scenarios. When uninitialized variables are identified, they may be mapped back to flag corresponding lines of the source code - which may be used by a programmer to debug the code.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs) and/or one or more vision language models (VLMs), systems for performing light transport simulation, systems for performing collaborative content creation for 3D assets, systems implemented at least partially using cloud computing resources, and/or other types of systems.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, included wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508. In some embodiments, one or more functions of the variable analysis pass 122 and/or compiler system 110 may be executed by CPU(s) 506, GPU(s) 508 and/or logic unit(s) 520.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM). In some embodiments, one or more functions of the variable analysis pass 122 and/or compiler system 110 may be executed by one or more of the node C.R.s 616(1)-616(N).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R. s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
generate, using a control flow graph representing a set of instructions corresponding to source code of a program, a first map that identifies one or more declared variables from the set of instructions and one or more variable definition instructions from the set of instructions;
update the first map based at least on propagation of an indication of the one or more variable definition instructions to one or more basic blocks of the control flow graph;
evaluate one or more definition-use chains associated with the control flow graph based at least on a correlation of variable use instructions in the one or more definition-use chains with the one or more basic blocks based on the first map; and
generate an output representing a usage of one or more uninitialized variables in the set of instructions based on the correlation.

2. The one or more processors of claim 1, wherein the set of insructions comprise a static single assignment (SSA) intermediate representation (IR) of the program source code.

3. The one or more processors of claim 1, wherein the one or more processors are further to generate a report comprising at least an indication of one or more portions of the program source code that use the one or more uninitialized variables.

4. The one or more processors of claim 1, wherein the one or more processors are further to propagate the indication of the one or more variable definition instructions to the one or more basic blocks of the control flow graph based on a tree corresponding to a set of basic blocks included in the control flow graph.

5. The one or more processors of claim 1, wherein the one or more processors are further to compile the set of insructions into a machine-executable code based on the output representing the usage of one or more uninitialized variables indicating that the set of insructions does not include uninitialized variables.

6. The one or more processors of claim 1, wherein the one or more processors are further to identify the one or more basic blocks of the control flow graph in the first map based at least on one or more basic block identifiers that uniquely identify individual basic blocks of the control flow graph.

7. The one or more processors of claim 1, wherein the first map indicates, based at least on a basic block identifier (ID), when a declared variable used by the one or more basic blocks has been defined using at least one of the one or more variable definition instructions prior to an entry to the one or more basic blocks.

8. The one or more processors of claim 1, wherein the one or more processors are further to:
generate a second map that identifies one or more Phi functions from the set of instructions, wherein the second map associates the one or more Phi functions with a set of one or more basic blocks of the control flow graph that include the one or more Phi functions;
determine when variable inputs to the one or more Phi functions are reached by the one or more variable definition instructions based on a second correlation of the second map with the first map and the one or more definition-use chains associated with the control flow graph; and
generate the output representing the usage of one or more uninitialized variables further based on the second correlation.

9. The one or more processors of claim 8, wherein the one or more processors are further to:
perform a recursive flattening of the second map into a flattened list that associates the variable inputs to the one or more Phi functions with one or more basic block identifiers (IDs).

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for generating or presenting at least one of virtual reality content, augmented reality content, or mixed reality content;
a system for performing deep learning operations;
a system for performing real-time streaming;
a system implemented using an edge device;
a system implemented using a robot;
a system for performing conversational AI operations;
a system for generating synthetic data;
a system incorporating one or more virtual machines (VMs);
a system that implements one or more large language models (LLMS);
a system that implements one or more vision language models (VLMs);
a system implemented at least partially in a data center;
a system for performing generative AI operations;
a system implemented at least partially using a language model; or
a system implemented at least partially using cloud computing resources.

11. A system comprising one or more processors to:
generate a first map representative of one or more variables associated with a control flow graph, the control flow graph representing a set of instructions corresponding to source code of a program;
correlate one or more variable use instructions from the set of instructions with one or more basic blocks of the control flow graph based on the first map; and
generate an output representing a usage of one or more uninitialized variables in the set of instructions based on the correlation.

12. The system of claim 11, wherein the one or more processors are further to:
generate the first map to identify one or more declared variables from the set of instructions and one or more variable definition instructions from the set of instructions that assign one or more values to the one or more declared variables.

13. The system of claim 11, wherein the one or more processors are further to:
correlate one or more variable use instructions based at least on one or more definition-use chains associated with the control flow graph.

14. The system of claim 11, wherein the set of instructions comprise a static single assignment (SSA) intermediate representation (IR) of the program source code.

15. The system of claim 11, wherein the one or more processors are further to propagate an indication of one or more variable definition instructions to the one or more basic blocks of the control flow graph based on a dominator tree corresponding to a set of basic blocks included in the control flow graph.

16. The system of claim 11, wherein the first map indicates, based at least on a basic block identifier (ID), when a declared variable used by the one or more basic blocks has been defined using at least one variable definition instruction of one or more variable definition instructions prior to an entry to the one or more basic blocks.

17. The system of claim 11, wherein the one or more processors are further to:
generate a second map that identifies one or more Phi functions from the set of instructions;
determine when variable inputs to the one or more Phi functions are reached by one or more variable definition instructions based on a second correlation of the second map with the first map and one or more definition-use chains associated with the control flow graph; and
generate the output representing the usage of one or more uninitialized variables further based on the second correlation.

18. The system of claim 17, wherein the one or more processors are further to:
generate a report comprising at least an indication of one or more portions of the source code that use the one or more uninitialized variables.

19. The system of claim 11, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for generating or presenting at least one of virtual reality content, augmented reality content, or mixed reality content;
a system for performing deep learning operations;
a system for performing real-time streaming;
a system implemented using an edge device;
a system implemented using a robot;
a system for performing conversational AI operations;
a system for generating synthetic data;
a system incorporating one or more virtual machines (VMs);
a system implemented at least partially in a data center;
a system that implements one or more large language models (LLMS);
a system that implements one or more vision language models (VLMs);
a system for performing generative AI operations;
a system implemented at least partially using a language model; or
a system implemented at least partially using cloud computing resources.

20. A system comprising:
processing circuitry to generate an output representing a usage of one or more uninitialized variables in a set of instructions corresponding to a program based at least on one or more maps associated with a control flow graph of the set of instructions, and to correlate one or more variable use instructions from the set of instructions with one or more basic blocks of the control flow graph based on the one or more maps.
